(19) United States
(12) Patent Application Publication
(10) Pub. No.: US 2017/0006505 A1
(43) Pub. Date: Jan. 5, 2017

(54) Method for Resource Contention and Associated Access Point

(71) Applicant: TELEFONAKTIEBOLAGET LM ERICSSON (PUBL), Stockholm (SE)

(72) Inventors: Jinhua LIU, Beijing (CN); Zhan ZHANG, Beijing (CN)

(21) Appl. No.: 15/039,765

(22) PCT Filed: Dec. 9, 2013
(86) PCT No.: PCT/CN2013/088868

§ 371 Date: May 26, 2016

(51) Int. Cl. H04W 28/26; H04W 16/10

(52) U.S. Cl. CPC H04W 28/26; H04W 16/10

(57) ABSTRACT

The present disclosure discloses a method used in an AP for resource contention with one or more neighboring APs and an associated AP. The method comprises the steps of: obtaining a resource contention priority for the AP to contend for a radio resource, the resource contention priority for the AP being complementary with one or more resource contention priorities for the one or more neighboring APs to contend for the radio resource; and contending for the radio resource with the one or more neighboring APs based on the resource contention priority of the AP.

### TECHNICAL FIELD

The present disclosure generally relates to wireless communications, and particularly, to a method for resource contention, and an associated Access Point (AP).

### BACKGROUND

Currently, data traffic is boosting rapidly while there exists clear bandwidth limit in low frequency bands. The vendors are seeking to use even higher frequency bandwidth in order to reach even higher data rate. An Ultra Density Network (UDN) emerged at this moment.

For UDN, AP nodes are super-densely deployed and mainly run in high frequency band, either license bands or unlicensed bands. A typical deployment for a UDN is in highly populated areas such as hot spots, office building, or downtown area at cities, where there are demands for high-data rate services. The allocated frequency bandwidth of one radio channel may vary for several tens of MHz to wider than 1 GHz. In order to (1) simplify complexity in dealing with interferences due to close APs, (2) reduce cost of transceiver design, and (3) ensure efficient resource sharing between neighboring APs, the resource allocation between neighboring cells (or APs) should be a full contention based scheme, rather than a static allocation based scheme.

To this end, it is necessary for UDN to utilize a higher carrier frequency and a wider bandwidth, so as to reach an even higher data rate. In order to have a high flexibility and low cost of deployment in UDN, wireless backhaul may be necessary to support some UDN APs. These UDN APs cannot obtain synchronization signal via wired networks. Moreover, in order to reach a high data rate, dynamic frequency division and allocation of radio resources are needed for neighboring UDN APs. An efficient time and frequency synchronization scheme is necessary, so as to keep an as small as possible frequency offset between neighboring APs in an acceptable level.

Furthermore, in order to reach an ultra-high data rate, it is expected that a radio channel is usually has a large bandwidth, e.g., varying for several tens of MHz to larger than 1 GHz. It is also expected that the frequency channel is not preconfigured in a fixed style for an AP but certain radio channel sharing protocol is to be used in a UDN.

For a UDN, as one of the most important future ratio access networks, the network side should have the full controllability of the radio resource, in order to ensure Quality of Service (QoS) and high radio efficiency.

From this perspective, a radio resource management scheme with better network owned controllability is in demand.

### SUMMARY

An objective of the present disclosure is to disclose a low-complexity radio resource management scheme and procedure for UDN.

To achieve the objective, according to a first aspect of the present disclosure, there is provided a method used in an AP for resource contention with one or more neighboring APs. The method includes the steps of: obtaining a resource contention priority for the AP to contend for a radio resource, the resource contention priority for the AP being complementary with one or more resource contention priorities for the one or more neighboring APs to contend for the radio resource; and contending for the radio resource with the one or more neighboring APs based on the resource contention priority of the AP.

According to a second aspect of the present disclosure, there is provided an AP for resource contention with one or more neighboring APs. The AP includes an obtaining unit configured to obtain a resource contention priority for the AP to contend for a radio resource. The resource contention priority for the AP is complementary with one or more resource contention priorities for the one or more neighboring APs to contend for the radio resource. The AP further includes a contending unit configured to contend for the radio resource with the one or more neighboring APs based on the resource contention priority of the AP.

As APs are preconfigured with different priorities to compete for radio resource blocks corresponding to different frequency bands (or radio channels), radio resource request conflicting possibilities are minimized and the spectrum utilization is enhanced.

### BRIEF DESCRIPTION OF THE DRAWINGS

The above and other objectives, features, and advantages of the present disclosure will become apparent from the following descriptions on embodiments of the present disclosure with reference to the drawings, in which:

FIG. 1 schematically illustrates an example UDN scenario where the present disclosure may be applied;

FIG. 2 is a flowchart schematically illustrating a resource contention method 200 according to some embodiments of the present disclosure;

FIG. 3 is a schematic block diagram of AP 300 according to some embodiments of the present disclosure; and

FIG. 4 schematically shows an embodiment of an arrangement 400 which may be used in the AP 300.

### DETAILED DESCRIPTION OF THE PREFERRED EMBODIMENTS

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Currently, an IEEE-802.11 system mainly runs in the unlicensed frequency band. Carrier Sensing Multiple Access/Collision Avoidance (CSMA/CA) is usually in such an IEEE-802.11 system, so as to avoid collision.

In CSMA/CA, nodes (either terminals or APs) are contending for resources via “listening before talk” mechanism. That is, a station can transmit a signal only when a detected signal is lower than a certain predefined level, so as to avoid colliding. Upon each colliding, each node should increase its sensing time in order to avoid further colliding. In addition, the nodes can also use Request To Send (RTS) and Clear To Send (CTS) signaling to further reduce the hidden problem. In the RTS and CTS, time indication (NAV) on how long the channel will be occupied by the two nodes is included in the RTS and CTS. The neighboring nodes which detected the RTS and CTS should start a timer with the period shown in RTS or CTS and wait until the timer expires. When the timer expires, the node starts another sensing on the availability of channel.

By such a scheme, each node has a chance to get the radio resource. Such a scheme works well when the traffic is rather low. However, in case of high traffic load, resource efficiency becomes rather low due to collision, therefore, also the QoS cannot be ensured for all served terminals.

That is, in high traffic load case, such an allocation scheme results in high collision ratio and large overhead in high traffic load case, and it is hard to ensure the QoS of the system.

Apparently, the existing collision avoidance schemes such as CSMA/CA cannot be directly used in UDN as UDN is of high traffic load.

FIG. 1 schematically illustrates an example UDN scenario where the present disclosure may be applied. As illustrated in FIG. 1, seven APs 101-107 are distributed in a UDN 100. The present disclosure provides the capability for two stations to communicate with each AP and thereby get connectivity to UDN. For example, two stations 110 and 120 are served by AP 101. Each of the remaining APs may have one or more stations, or may not have any station. For example, AP 102 serves only one station, AP 105 serves three stations, and AP 107 does not serve any station. Of course, the present disclosure is not limited to the scenario as illustrated in FIG. 1. The present disclosure may be also applied to any other number of APs, each of which has any other number of stations to be served.

Each AP takes a responsibility to contend for certain radio resource blocks and a terminal (or station) is not allowed to contend for the resource controllability. For example, AP 101 is responsible for contending for certain radio resource blocks instead of stations 110 and 120.

For each AP, a resource contention priority may be pre-assigned for each radio channel. For its neighboring APs, respective resource contention priorities are pre-assigned in complementary style for each radio channel. To be specific, AP 101 may be pre-assigned with a certain resource contention priority for a radio channel, and AP 101's neighboring APs, such as APs 102, 103, 104 . . . , may be pre-assigned with resource contention priorities, which are complementary with the resource contention priority for AP 101. For example, assume that there are only seven APs as shown in FIG. 1, and there are seven priorities for these APs. AP 101 may be pre-assigned with a first priority, and its closet neighboring APs, i.e., AP 103 may be pre-assigned with the seventh priority, so as to significantly reduce the possibility for contending between AP 101 and AP 103.

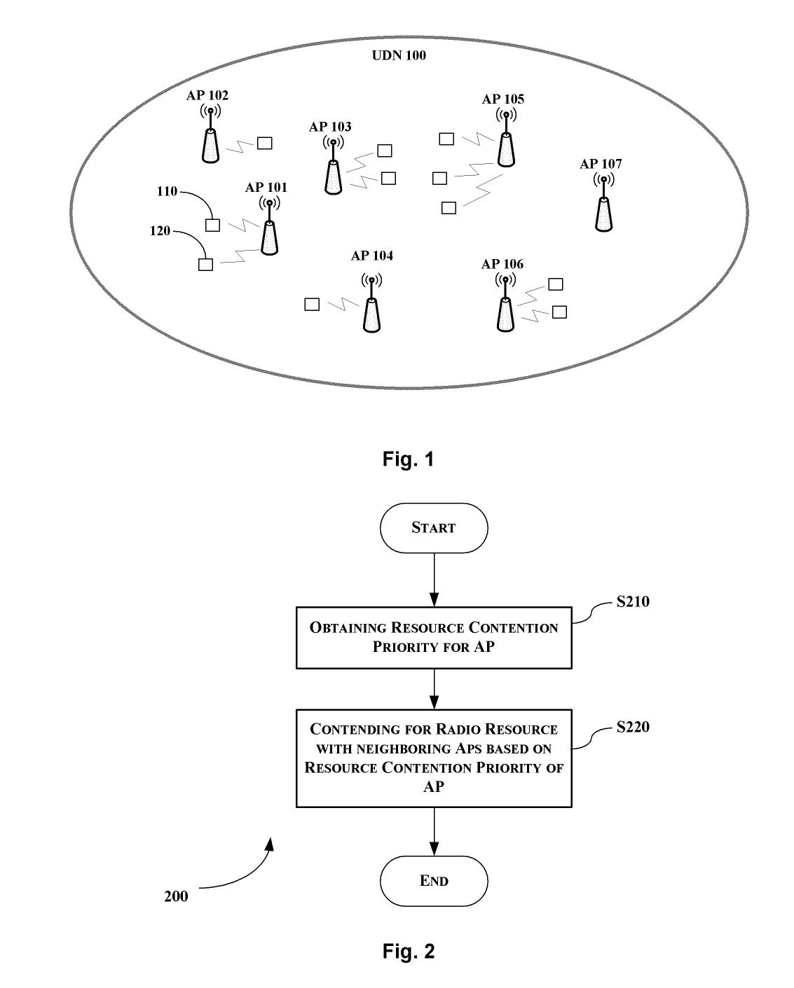

FIG. 2 is a flowchart schematically illustrating a resource contention method 200 according to some embodiments of the present disclosure. In particular, the resource contention method is used by an AP (e.g., AP 101 in FIG. 1) for contending for a radio resource with one or more neighboring APs (e.g., one or more of APs 102, 103, 104, . . . ) For example, the radio resource may include one of the following: one or more frequency sub-channels; one or more time sub-channels; one or more sub-channels channelized by codes; or one or more spatial sub-channels.

At step S210, the AP obtains a resource contention priority for the AP to contend for a radio resource. The resource contention priority for the AP is complementary with one or more resource contention priorities for the one or more neighboring APs to contend for the radio resource.

In this case, for example, the AP may contend for a radio resource with higher resource contention priority first before contending for radio resources with lower resource contention priorities. Furthermore, the AP may take, e.g., UE capability, into consideration when determining a target radio resource to be contended for. To be specific, the AP may determine a radio resource with the highest priority that served UEs can support, as the target radio resource.

At step S220, the AP contends for the radio resource with the one or more neighboring APs based on the resource contention priority of the AP.

By this way, resource collisions between the AP and its neighboring APs can be maximally reduced.

The method 200 may be particularly described in combination with the scenario as shown in FIG. 1.

Specifically, at step S210, AP 101 obtains a resource contention priority for AP 101 contending for a radio resource. The resource contention priority for AP 101 is complementary with one or more resource contention priorities for one or more of APs 102, 103, 104 . . . contending for the radio resource. At step S220, AP 101 contends for the radio resource with the one or more of APs 102, 103, 104 . . . based on the resource contention priority of AP 101.

In one implementation, the resource contention priority may be represented by using one or more back-off windows specified for the AP. Here, the concept of “back-off window” has been specified in the existing CSMA/CA standard. To be specific, an AP with the higher resource contention priority for a certain radio resource may be configured with the shorter sensing time. At certain resource block, APs with different priority of using it have different contention window sizes for back-off upon a collision.

In this implementation, if a size of each of the one or more back-off windows is larger, the resource contention priority is lower. If the size of each of the one or more back-off windows is smaller, the resource contention priority is higher.

Alternatively, the resource contention priority may be represented by using one or more time durations of channel-clearance-detection/Clear Channel Assessment (CCA) specified for the AP. Here, the concept of “channel-clearance-detection” or “CCA” has been specified in the existing CSMA/CA standard. To be specific, if each of the one or more time durations of channel-clearance-detection or CCA is larger, the resource contention priority is lower. If each of the one or more time durations of channel-clearance-detection or CCA is smaller, the resource contention priority is higher.

In another implementation, the resource contention priority may be represented by a predefined order to contending for radio resources. As an example, AP 101 may be configured as contending for radio resources following a certain sequence and its closest neighboring AP (e.g., AP 103) may be configured as contending for the radio resources following an opposite sequence. In such configurations, for example, AP 101 may firstly contend for resource 3, then for resource 2, and finally for resource 1, while AP 103 may firstly contend for resource 1, then for resource 2, and finally for resource 3. In this way, possibility for contending between AP 101 and AP 103 may be significantly reduced.

In a further implementation, step S210 may be implemented via various manner.

One feasible manner to implement step S210 is to receive the resource contention priority for the AP from Administration And Maintenance (OAM) interface. For example, the AP may receive from the OAM interface a configuration indicating the resource contention priority.

Another feasible manner to implement step S210 is to receive the resource contention priority for the AP from a network controller for the AP. For example, the network controller for the AP may be a network node having a function of coordinating between the AP and its neighboring APs.

A further feasible manner to implement step S210 is to identify the resource contention priority from an identification of the AP, such as Medium Access Control (MAC) IDentification (ID).

Yet another feasible manner to implement step S210 is to receive, from the one or more neighboring APs, one or more messages indicating the resource contention priorities of the one or more neighboring APs, and to determine the resource contention priority of the AP based on the received one or more messages.

In yet another implementation, the resource contention priority for the AP may be based on a service area of the AP. It is well-known that different APs may cover service areas of different sizes or different service capabilities such as different numbers of UEs occurring in the service areas. In case that bandwidth is either wide or disjoint distributed, an AP covering smaller area may be assigned with a lower priority to contend for low frequency channels, so that APs with larger coverage can use the low frequency channels with a relatively higher probability to fully utilize the less path loss due to lower frequency.

As an alternative, the resource contention priority for the AP may be based on a propagation environment of the AP. For instance, an AP, whose coverage area has more obstacles (rich multipath), can be assigned with higher contention priority for low frequency resources, so that the AP can have a lower shadow loss.

As another alternative, the resource contention priority for the AP may be based on traffic load statistics of the AP. For example, an AP, which usually has higher traffic load, can be assigned with more high-contention-priority resources, so that the AP can gain more radio resource when necessary.

In one implementation, the resource contention priority for the AP may be presented by switching on or off the AP in certain durations.

According to the present disclosure, the radio resource may be of time domain, frequency domain, code domain, or spatial domain. To be specific, the resource contention method 200 may be performed in any of time domain, frequency domain, code domain and spatial domain or any combination of these four domains.

One radio resource may be divided into different resource blocks in time domain, frequency domain, or code domain. For one AP, different resource contention priorities may be pre-assigned for different resource blocks and the AP's neighboring APs are assigned with complementary priorities to contend for the same resource blocks.

Whenever each AP has a multiple-antenna array and its coverage may be divided into more than one sub-area (or sector) with good enough isolation, the complementary contention resource pre-assignment and priority setting may be arranged in spatial domain with cooperation between APs through a distributive negotiation or central control unit.

Furthermore, which domain(s) shall be used for the complementary resource contention priority pre-assignment may depend on multiple factors, e.g., availability of radio resource such as the number of available carriers, beam-forming capability of system, sectorization and physical layer modulation schemes etc.

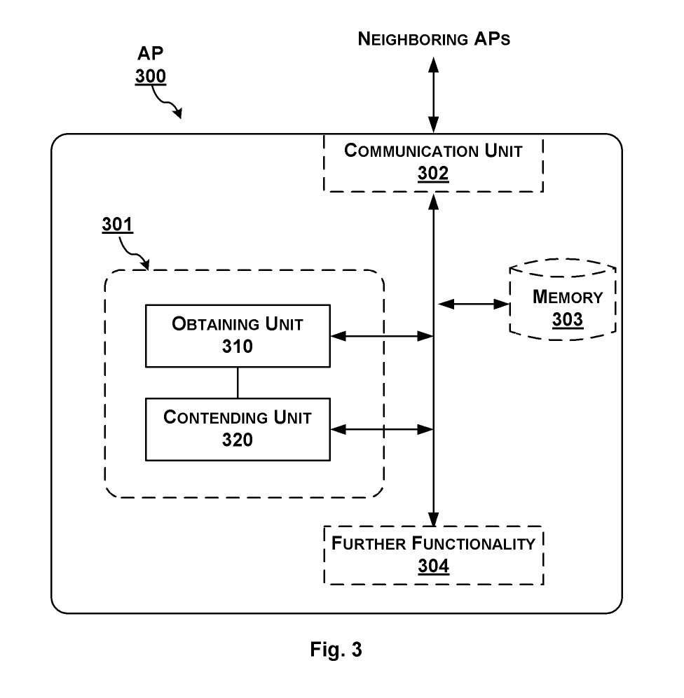

FIG. 3 is a schematic block diagram of AP 300 according to some embodiments of the present disclosure. The AP 300 is used for resource contention with one or more neighboring APs.

The part of AP 300 which is most affected by the adaptation to the herein described method, e.g., the method 200, is illustrated as an arrangement 301, surrounded by a dashed line. The AP 300 and arrangement 301 are further configured to communicate with other entities via a communication unit 302 which may be regarded as part of the arrangement 301. The communication unit 302 comprises means for wireless communication. The arrangement 301 or AP 300 may further comprise other functional units 304, such as functional units providing regular AP functions, and may further comprise one or more storage units 303.

The arrangement 301 could be implemented, e.g., by one or more of: a processor or a micro processor and adequate software and memory for storing of the software, a Programmable Logic Device (PLD) or other electronic component(s) or processing circuitry configured to perform the actions described above, and illustrated, e.g., in FIG. 2.

The arrangement part of the AP 300 may be implemented and/or described as follows.

Referring to FIG. 3, AP 300 may include an obtaining unit 310 and a contending unit 320.

The obtaining unit 310 may obtain a resource contention priority for the AP to contend for a radio resource. The resource contention priority for the AP may be complementary with one or more resource contention priorities for the one or more neighboring APs to contend for the radio resource.

As a non-limiting example, the obtaining unit 310 may receive the resource contention priority for the AP from OAM interface.

As another non-limiting example, the obtaining unit 310 may receive the resource contention priority for the AP from a network controller for the AP.

As a further non-limiting example, the obtaining unit 310 may identify the resource contention priority from an identification of the AP.

As yet another non-limiting example, the obtaining unit 310 may receive, from the one or more neighboring APs, one or more messages indicating the resource contention priorities of the one or more neighboring APs, and determine the resource contention priority of the AP based on the received one or more messages.

The contending unit 320 may contend for the radio resource with the one or more neighboring APs based on the resource contention priority of the AP.

In one implementation, the resource contention priority may be represented by using one or more back-off windows specified for the AP. In this case, if a size of each of the one or more back-off windows is larger, the resource contention priority is lower; and if the size of each of the one or more back-off windows is smaller, the resource contention priority is higher.

Alternatively, the resource contention priority may be represented by using one or more time durations of channel-clearance-detection/CCA specified for the AP. In this case, if each of the one or more time durations of channel-clearance-detection or CCA is larger, the resource contention priority is lower. If each of the one or more time durations of channel-clearance-detection or CCA is smaller, the resource contention priority is higher.

In another implementation, the resource contention priority may be represented by a predefined order to contend for radio resources.

In a further implementation, the resource contention priority for the AP may be based on one of the following: a service area of the AP; a propagation environment of the AP; or traffic load statistics of the AP.

In yet another implementation, the radio resource is of time domain, frequency domain, code domain, or spatial domain.

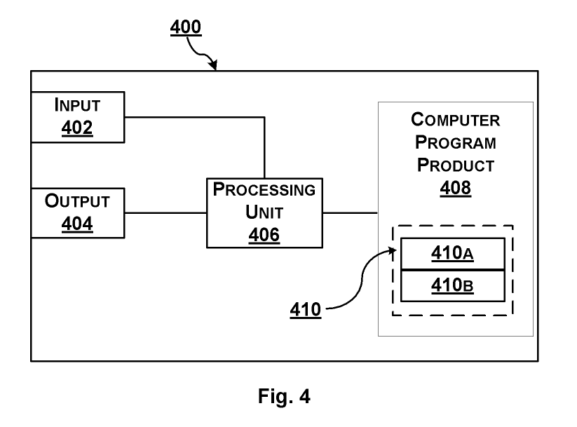

FIG. 4 schematically shows an embodiment of an arrangement 400 which may be used in the AP 300. Comprised in the arrangement 400 are here a processing unit 406, e.g., with a Digital Signal Processor (DSP). The processing unit 406 may be a single unit or a plurality of units to perform different actions of procedures described herein. The arrangement 400 may also comprise an input unit 402 for receiving signals from other entities, and an output unit 404 for providing signal(s) to other entities. The input unit and the output unit may be arranged as an integrated entity or as illustrated in the example of FIG. 3.

Furthermore, the arrangement 400 comprises at least one computer program product 408 in the form of a non-volatile or volatile memory, e.g., an Electrically Erasable Programmable Read-Only Memory (EEPROM), a flash memory and a hard drive. The computer program product 408 comprises a computer program 410, which comprises code/computer readable instructions, which when executed by the processing unit 406 in the arrangement 400 causes the arrangement 400 and/or the AP in which it is comprised to perform the actions, e.g., of the procedure described earlier in conjunction with FIG. 2.

The computer program 410 may be configured as a computer program code structured in computer program modules 410A and 4106.

Hence, in an exemplifying embodiment when the arrangement 400 is used in the AP 300, the code in the computer program of the arrangement 400 includes an obtaining module 410A, for obtaining a resource contention priority for the AP to contend for a radio resource, wherein the resource contention priority for the AP is complementary with one or more resource contention priorities for the one or more neighboring APs to contend for the radio resource. The code in the computer program 410 further includes a contending module 410B, for contending for the radio resource with the one or more neighboring APs based on the resource contention priority of the AP.

The computer program modules could essentially perform the actions of the flow illustrated in FIG. 2, to emulate the arrangement 301 in the AP 300. In other words, when the different computer program modules are executed in the processing unit 406, they may correspond, e.g., to the units 310 and 320 of FIG. 3.

Although the code means in the embodiments disclosed above in conjunction with FIG. 4 are implemented as computer program modules which when executed in the processing unit causes the device to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the BS.

Although the present technology has been described above with reference to specific embodiments, it is not intended to be limited to the specific form set forth herein. For example, the embodiments presented herein are not limited to UDN; rather they are equally applicable to other appropriate networks, which include densely deployed nodes. The technology is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

1. A method used in an Access Point, AP, for resource contention with one or more neighboring APs, the method comprising the steps of:
obtaining a resource contention priority for the AP to contend for a radio resource, the resource contention priority for the AP being complementary with one or more resource contention priorities for the one or more neighboring APs to contend for the radio resource; and
contending for the radio resource with the one or more neighboring APs based on the resource contention priority of the AP.

2. The method according to claim 1, wherein the resource contention priority is represented by using one or more back-off windows specified for the AP.

3. The method according to claim 2, wherein
if a size of each of the one or more back-off windows is larger, the resource contention priority is lower; and
if the size of each of the one or more back-off windows is smaller, the resource contention priority is higher.

4. The method according to claim 1, wherein the resource contention priority is represented by a predefined order to contend for radio resources.

5. The method according to claim 1, wherein the step of obtaining the resource contention priority for the AP includes:
receiving the resource contention priority for the AP from Administration And Maintenance, OAM, interface.

6. (canceled)

7. The method according to claim 1, wherein the step of obtaining the resource contention priority for the AP includes:
identifying the resource contention priority from an identification of the AP.

8. The method according to claim 1, wherein the step of obtaining the resource contention priority for the AP includes:
receiving, from the one or more neighboring APs, one or more messages indicating the resource contention priorities of the one or more neighboring APs; and
determining the resource contention priority of the AP based on the received one or more messages.

9. The method according to claim 1, wherein the resource contention priority for the AP is based on one of the following:
a service area of the AP;
a propagation environment of the AP; or
traffic load statistics of the AP.

10. (canceled)

11. An Access Point, AP, for resource contention with one or more neighboring APs, the AP comprising:
one or more processors configured to obtain a resource contention priority for the AP to contend for a radio resource, the resource contention priority for the AP being complementary with one or more resource contention priorities for the one or more neighboring APs to contend for the radio resource; and
the one or more processor configured to contend for the radio resource with the one or more neighboring APs based on the resource contention priority of the AP.

12. The AP according to claim 11, wherein the resource contention priority is represented by using one or more back-off windows specified for the AP.

13. The AP according to claim 12, wherein
if a size of each of the one or more back-off windows is larger, the resource contention priority is lower; and
if the size of each of the one or more back-off windows is smaller, the resource contention priority is higher.

14. The AP according to claim 11, wherein the resource contention priority is represented by a predefined order to contend for radio resources.

15. The AP according to claim 11, wherein the one or more processors are configured to:
receive the resource contention priority for the AP from Administration And Maintenance, OAM, interface.

16. (canceled)

17. The AP according to claim 11, wherein the one or more processors are configured to:
identify the resource contention priority from an identification of the AP.

18. The AP according to claim 11, wherein the one or more processors are configured to:
receive, from the one or more neighboring APs, one or more messages indicating the resource contention priorities of the one or more neighboring APs; and
determine the resource contention priority of the AP based on the received one or more messages.

19. The AP according to claim 11, wherein the resource contention priority for the AP is based on one of the following:
a service area of the AP;
a propagation environment of the AP; or
traffic load statistics of the AP.

20. (canceled)

21. An Access Point, AP, for resource contention with one or more neighboring APs, the AP comprising a processor and a memory, said memory containing instructions executable by said processor, whereby said AP is operative to:
obtain a resource contention priority for the AP to contend for a radio resource, the resource contention priority for the AP being complementary with one or more resource contention priorities for the one or more neighboring APs to contend for the radio resource; and
contend for the radio resource with the one or more neighboring APs based on the resource contention priority of the AP.

22. (canceled)

23. The AP according to claim 21, wherein said obtaining a resource contention priority is to receive the resource contention priority for the AP from OAM interface, or from a network controller for the AP.

24. The AP according to claim 21, wherein said obtaining a resource contention priority is to:
receive, from the one or more neighboring APs, one or more messages indicating the resource contention priorities of the one or more neighboring APs; and
determine the resource contention priority of the AP based on the received one or more messages.
